(19) United States
(12) Patent Application Publication
(10) Pub. No.: US 2001/0048751 A1
(43) Pub. Date: Dec. 6, 2001

(54) Elongate panel loudspeaker

(76) Inventor: Christien Ellis, Hertfordshire (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/850,137

(22) Filed: May 8, 2001

Related U.S. Application Data
(60) Provisional application No. 60/204,747, filed on May 17, 2000.

(30) Foreign Application Priority Data
May 8, 2000 (GB) 0010998.3

(51) Int. Cl. H04R 25/00; H04R 9/06

(52) U.S. Cl. 381/431; 381/150

(57) ABSTRACT

A panel loudspeaker has a panel (61) which supports resonant bending wave modes imparted by a transducer (63) mounted on the panel, and a panel suspension (71) for suspending the panel on a support (67). The panel (61) is elongate and the panel suspension (71) is located in the region of each short end of the panel to partially restrain the short ends so that the motion of a central region of the panel is significantly greater than the motion of the short ends. A television comprising a screen and a molding surrounding the screen may incorporate one or more panel loudspeakers as described above mounted in the molding adjacent the screen.

This application claims the benefit of provisional application No. 60/204,747, filed May 17, 2000.

### BACKGROUND

The invention relates to panel loudspeakers, in particular loudspeakers which produce an acoustic output using resonant bending wave modes.

Loudspeakers such as those taught in WO97/09842 of New Transducers Limited are generally known as distributed mode loudspeakers. In the design of such loudspeakers, frequencies of resonant bending wave modes associated with one axis of the panel are interleaved with frequencies of resonant bending wave modes associated with a normal axis so as to produce as even a spacing of resonant bending wave modes in frequency as possible. Such resonant bending wave loudspeakers have the beneficial effect of unusually wide directivity. WO97/09842 teaches preferred aspect ratios of 1:1.13 and 1:1.41 for an isotropic panel that provide usefully interleaved frequency distributions of modal resonances.

Another panel loudspeaker is known from U.S. Pat. No. 4,426,556 which describes a panel loudspeaker comprising a generally flat vibrating plate and first and second magnetic drives for driving the plate as an acoustic radiator. The vibrating plate is suspended in a support so that the plate moves freely when operating as an acoustic radiator.

### SUMMARY OF THE INVENTION

According to the invention, there is a provided a panel loudspeaker comprising a panel which supports resonant bending wave modes, a transducer mounted on the panel to excite resonant bending wave modes to produce an acoustic output, a panel support and a panel suspension for suspending the panel on the support, characterised in that the panel is elongate and the panel suspension is located in the region of each short end of the panel to partially restrain the short ends so that the motion of a central region of the panel is significantly greater than the motion of the short ends.

Since the panel is elongate, the panel has a short axis and a long axis. The fundamental frequency will be determined by the length and the bending stiffness along the long axis, which will give a low fundamental frequency for an elongate panel. Bending waves associated with the long axis occur along the length of the panel and involve bending about an axis across the width of the panel. At higher frequencies, the short axis will be effectively modal and cross modes will appear. Cross modes are modes in which the panel bends across its width with the axis of bending along the length of the panel.

Although the resonant bending wave modes will be sparse in the region near the fundamental frequency, the density of modes will sufficiently increase at frequencies in which both axes are effectively modal. Preferably, the panel is for operation over a predetermined frequency range of interest in which modes associated with both axes are excited and thus there are resonant bending wave modes extending both along and across the panel over the whole of the predetermined frequency range. By exciting modes both along and across the panel much more even sound radiation can be obtained, i.e. a more even distribution of the modes over the frequency range may be obtained.

The invention provides an elongate loudspeaker with an effective broad frequency response extending from below 80 Hz up to 20K Hz at a level balanced for good sound quality. Suspending the panel so as to allow the central region of the panel to move significantly greater than the short ends appears critical to providing a good acoustic output. The central region may move twice, three times or four times the distance of the short ends. The short ends may be substantially stationary. The elongate panel of the present invention may thus achieve good acoustic results, without using the optimal ratios given in WO97/09842.

The panel may be provided with a longitudinal reinforcement member along its length on one or both sides of the panel. The reinforcement member may extend across only part of the width of the panel. The reinforcement member may be provided on a central region of the area of the panel in the form of a strip across about 3% to about 40% of the width of the panel. For example, such reinforcement may be balancing skins of higher tensile stiffness.

The strip(s) are added to increase the bending stiffness along the long axis (i.e. about the short axis) although the strips will also increase the bending stiffness along the short axis (i.e. about the long axis) to a lesser extent. The increased stiffening may raise the fundamental frequency and may also create a much smoother acoustic transition at higher frequencies where the cross modes start to come into effect.

Depending on the width of the strip, the transducer may be mounted on the strip, bridge the edge of the strip or be placed outside the strip, on the rest of the panel. More than one transducer may be mounted on the panel. A first transducer may be mounted centrally on the strip and a second transducer may be mounted to bridge the edge of the strip. Different transducer coupling conditions in respect of mechanical impedance arise from these alternatives and the selection of a suitable alternative may serve to balance and/or control the spectral power of the panel operating as an acoustic radiator over the frequency range of interest.

The suspension may comprise U-shaped resilient mountings attached to each opposed end of the panel. Each mounting may extend approximately up to 30% along the length of the panel from each end. Alternatively, each mounting may extend up to 10% of the distance down the panel from each short end. In an alternative embodiment, the suspension may comprise four resilient mounting blocks with each mounting block attached to the panel in the region of a respective corner of the panel. In this way, each block acts as a pivot point about which the panel may move. The four suspension blocks approximate to the U-shaped suspension.

The suspension may further comprise one or more tuning blocks which are each mounted to the panel to suppress a particular unwanted resonance in the panel. The tuning block(s) may be mounted on the panel between the suspensions at each short end of the panel. The suspension and/or tuning block may be made from a resilient foam.

Where the panel is not attached to the support by the suspension, an air gap may be defined between each long edge and panel support so that the long edge moves in the air gap when the panel loudspeaker is producing an acoustic output. The panel movement is contained within the air gap and the panel support functions as a baffle. Alternatively, the panel may be attached to the support by a highly compliant soft foam in the regions not attached by the resilient suspension. The use of such a soft foam should not hinder the movement of the central region of the panel.

The panel may have an aspect ratio in the range of about 1.7:1 to about 10:1 and preferably in the range of about 3:1 to about 5:1. The aspect ratio is defined as the ratio of the length of the long side of the panel to the length of the short side. The transducer is preferably an inertial transducer and may be a moving coil transducer. More than one transducer may be mounted to the panel and the transducers may be connected in parallel to drive the panel.

The support may be an open frame or an enclosure which encloses a rear face of the panel. The enclosure may comprise a vent which may be centrally located in a rear face of the enclosure. The panel loudspeaker may be mounted in a baffle which may for example be arranged only along one side of the loudspeaker.

Damping and/or mass loading may also be used to improve the acoustic output, e.g. by enhancing the modal distribution of the loudspeaker. The panel loudspeaker may further comprise at least one mass and/or damping pad mounted to the panel. The damping pad may be mounted at a transducer location. The transducer may be mounted to the panel by a mounting coil, e.g. the coil of a moving coil transducer, and the damping pad may be located within the coil. The or each mass may be added to the panel at selected positions to enhance the acoustic output.

According to a second aspect of the invention, there is provided a television comprising a screen, a moulding surrounding the screen, and at least one panel loudspeaker as described above mounted in the moulding adjacent the screen. The elongate shape of the loudspeaker may make it particularly suitable for mounting in the moulding of a television. Furthermore, as outlined above the loudspeaker may provide the beneficial effect of unusually wide directivity of such resonant bending wave mode speakers, and a broad frequency range of operation.

The panel loudspeaker may be mounted so that the plane of the panel is parallel or perpendicular to the plane of the screen. Three panel loudspeakers may be mounted in the moulding to provide left, right and centre channels for audio reproduction.

### BRIEF DESCRIPTION OF THE DRAWING

For a better understanding of the invention, specific embodiments that set forth the best mode for carrying out the invention will now be described, purely by way of example, with reference to the accompanying drawing, in which:

FIG. 1 is a plan view of a panel loudspeaker according to a first aspect of the invention,

FIG. 2 is a plan view of a frame for supporting the panel loudspeaker of FIG. 1,

FIG. 3 is a plan view of a panel loudspeaker according to a second aspect of the invention,

FIG. 4 is a plan view of an enclosure for housing the panel loudspeaker of FIG. 3,

FIG. 5 shows the frequency response (output in dB against frequency in Hz) for the panel loudspeaker of FIG. 3 in the frame shown in FIG. 4,

FIG. 6 is a plan view of a panel loudspeaker according to a third aspect of the invention,

FIG. 7 is a plan view of a frame for supporting the panel loudspeaker of FIG. 6,

FIG. 8 shows the frequency response for the panel loudspeaker of FIG. 6 mounted in the frame shown in FIG. 7,

FIG. 9a is an exploded view of a panel loudspeaker module for insertion in a television moulding,

FIG. 9b is a schematic plan view of the panel loudspeaker module of FIG. 9a,

FIG. 10 is a perspective rear and side view of a television with the panel loudspeaker module of FIGS. 9a and 9b mounted therein as shown in a cut-away section,

FIG. 11 shows the frequency response for the loudspeaker module of FIGS. 9a and 9b mounted as shown in FIG. 10,

FIG. 12 is a schematic plan view of an alternative panel loudspeaker module to that of FIGS. 9a and 9b,

FIG. 13 is a schematic plan view of another alternative panel loudspeaker to that of FIGS. 9a and 9b,

FIG. 14 is a schematic plan view of a panel loudspeaker according to a fourth aspect of the invention,

FIG. 15 shows the frequency response for the panel loudspeaker module of FIG. 14,

FIG. 16 is a perspective front and side view of a television incorporating a panel loudspeaker according to the invention in a side wall of the television,

FIG. 17 is a perspective front and top view of a television incorporating a panel loudspeaker according to the invention in a top wall of the television,

FIGS. 18a, 18b and 18c are three schematic side views of the panel loudspeaker of FIG. 9a showing three positions of the panel when operating as an acoustic radiator,

FIGS. 19a, 19b and 19c are three perspective laser plots of the panel loudspeaker of FIGS. 9a and 9b showing three positions of the panel when operating as an acoustic radiator, and

FIG. 20 is a schematic cross-section across the short axis of a panel loudspeaker according to the invention.

### DETAILED DESCRIPTION

In constructing a loudspeaker according to the invention, the teachings of WO97/09842 and WO00/78090, and other patent publications of New Transducers Limited are employed to determine panel materials, types of transducers, and the location of transducers on panel. The US counterparts of the above two published international applications, namely U.S. application Ser. No. 08/707,012 (filed Sep. 3, 1996) and U.S. application Ser. No. 09/589,753 (filed Jun. 9, 2000), are incorporated herein by reference.

The panels used are all capable of supporting a plurality of resonant bending wave modes and the transducers are mounted on the panels to excite bending wave modes in the panels so that the panels act as acoustic radiators. The panels are for operation over a predetermined frequency range of interest and have resonant bending wave modes extending both along and across the panels over the whole of the predetermined frequency range.

The transducers are vibration transducers, e.g. inertial moving coil transducers. The transducer position is determined to ensure a good modal distribution over the entire bandwidth of interest as described in WO97/09842 and U.S. application Ser. No. 08/707,012. Analysis of the modal distribution or alternatively a more empirical methodology, e.g. consideration of the frequency response may be used to determine the placement of the transducers.

Referring to FIG. 1, there is shown a panel loudspeaker comprising a panel 1 and two transducers 3, 5 mounted on the panel 1 to excite bending wave modes in the panel 1. The panel 1 is of rectangular form with a length of 345 mm and a width of 92 mm and thus has an aspect ratio of 3.75:1. The panel is approximately 3.5 mm thick and comprises a high stiffness foamed plastic core, e.g. Rohacell, sandwiched between two glass veil reinforced plastics skins.

The first transducer 3 is located 225 mm from a first short end 19 (or top) of the panel and 46 mm from an adjacent long side 20, i.e. along the long axis of the panel 1. The second transducer 5 is mounted 104 mm from said first end 19 and 35 mm from said long side 20.

The panel 1 has carbon reinforcement strips 7 mounted on each side of the panel. The reinforcement strips 7 extend along the length of the long axis of the panel and are centrally mounted with respect to the long sides of the panel. The width of each strip is approximately equal to the diameter of the first transducer 3 (i.e. approximately 19 mm) and the thickness is negligible. The first transducer 3 is located centrally on the long axis of the strip 7. The centre of the second transducer 5 coincides with an edge of a strip 7 and hence the second transducer 5 bridges the edge of a strip 7. Both transducers are coupled to the strip. By bridging the edge of the strip, the second transducer is coupled to the stiffest part of the reinforced panel and thus better results at high frequency are achievable.

Two brass masses 21, 23 in the form of discs are mounted to the panel 1. A first mass 21 of 7.2 g is mounted at a position 235 mm from the first short end 19 (or top) of the panel and 35 mm from an adjacent long side 20. A second mass of 2.3 g is mounted a position 71 mm from the first short end 19 of the panel along the long axis of the panel 1. A damping pad 25, e.g. of resilient damping material, is mounted on the panel 1 at the location of the second transducer 5. The damping pad is located within the locus of the coil of the transducer, i.e. within the coupling circle of the transducer coil to the panel.

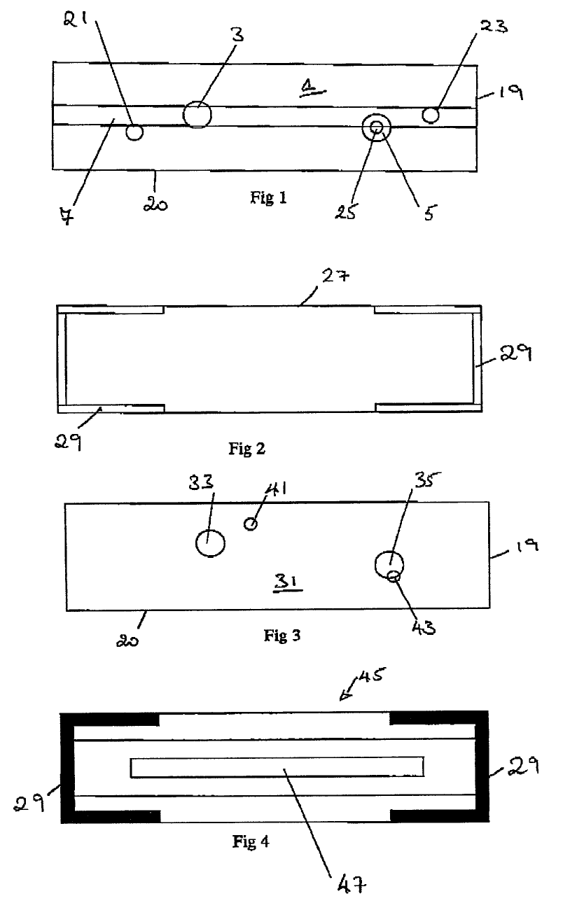

FIG. 2 shows an open frame 27 on which the panel 1 of FIG. 1 is mounted. The frame 27 dimensions correspond to those of the panel 1. The panel 1 is mounted to the extremities or short ends of the frame using a resilient polymer foam suspension 29 which is U-shaped. The suspension 29 restrains motion at the ends of the panel so that motion at the centre of the panel is significantly greater than that at the ends. Thus the suspension is generally clamp-like but does allow some motion of the ends of the panel. The foam suspension 29 is 5 mm deep by 5 mm wide and extends 100 mm from each short end of the frame. Hence the suspension extends approximately 30% along the length of the panel from each end.

Referring to FIG. 3, there is shown a panel loudspeaker comprising a panel 31 capable of supporting a plurality of resonant bending wave modes and two transducers 33, 35 mounted on the panel 31 to excite bending wave modes in the panel 31. The panel 31 is of rectangular form with a length of 495 mm and a width of 100 mm and thus has an aspect ration of 4.95:1. The panel is made of 3.5 mm Rohacell core compressed to a thickness of 2 mm. The core is sandwiched between two glass veil reinforced plastics skins. The first and second transducers 33, 35 are respectively located 326 mm and 145 mm from a short end 19 of the panel and 60 mm and 40 mm from an adjacent long side 20. The transducers are wired in parallel.

Two masses 41, 43 are mounted to the panel 1. A first mass 21 of 5 g is mounted at a position 285 mm from the short end 19 and 75 mm from the adjacent long side 20. A second mass of 3 g is mounted a position 145 mm from the first short end 19 and 40 mm from the adjacent long side 20. The masses are added at selected positions to enhance the modal distribution of the loudspeaker. The positions are selected by analysis or more empirical methods, in a similar manner to the transducer positions.

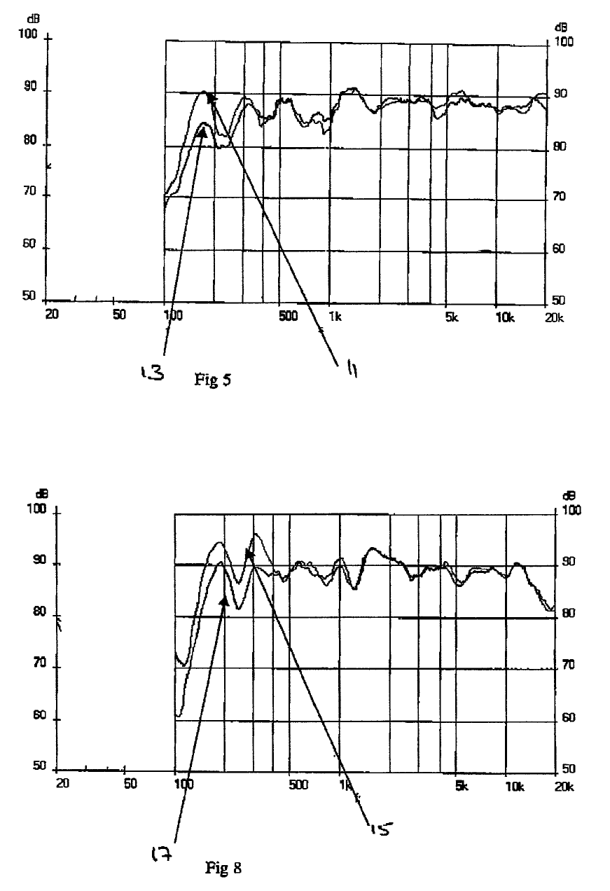

The panel 31 of FIG. 3 is mounted in an enclosure 45 shown in FIG. 4. The enclosure 45 is formed from an acoustically inert material, e.g. plastics, and has a vent 47 which is 25 mm by 320 mm. The vent 47 is located centrally of the enclosure 45. A vented enclosure is resonated at a single low frequency to adjust the frequency response, while such a structure behaves as enclosed at high frequency. The panel 1 is mounted to the enclosure by a U-shaped foam suspension 29 similar to that described for FIG. 2 whereby the rear face of the panel is substantially enclosed.

FIG. 5 shows the frequency response for the panel loudspeaker of FIG. 3 when mounted in the enclosure of FIG. 4, in other words in a substantially closed back arrangement. The upper and lower responses 11, 13 represent the responses (measured at 0.5 m away on axis) for the panel with and without a side baffle, respectively. As can be seen, there are good results in a broad frequency range from 100 Hz to 20 kHz and a beneficial acoustic response is provided over the whole of this very broad frequency range.

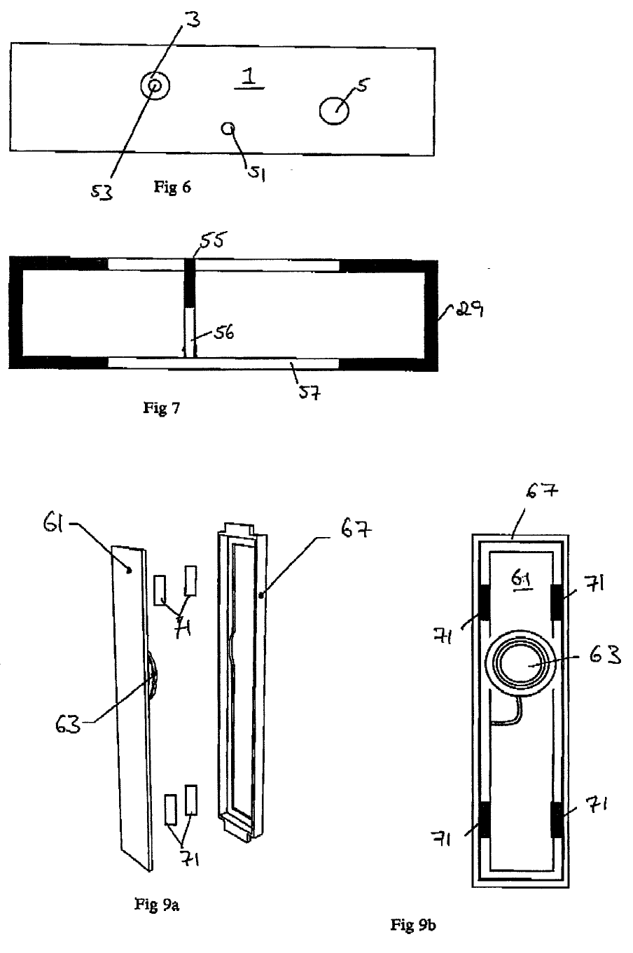

Referring to FIG. 6, there is shown a panel loudspeaker which is generally similar to that of FIG. 3 and thus reference numbers in common have been used. As in FIG. 3, the loudspeaker of FIG. 6 comprises a panel 1 and two transducers 3, 5 mounted on the panel. Both FIG. 3 and FIG. 6 embodiments have the same dimensioned panels and the same locations of the two transducers.

There is no panel reinforcing strip on the embodiment of FIG. 6 and only one mass 51 of 2.2 g is mounted to the panel 1. The mass is mounted at a position 240 mm from a panel short end 19 and 22 mm from the adjacent long side 20. A damping pad 53 which comprises a washer of 0.2 g is mounted on the panel 1 at the location of the second transducer 5. By combining the washer with the damping pad, a mass loaded damping pad is formed. The damping pad is made of any suitable damping material, e.g. foam and the washer is made of any non-magnetic metal, e.g. brass. The coil of the transducer surrounds the damping pad.

FIG. 7 shows an open extruded plastics frame 57 on which the panel 1 of FIG. 6 is mounted. The frame 57 dimensions correspond to those of the panel 1. The panel 1 is mounted to the extremities or short ends of the frame using a resilient foam suspension 29 which is U-shaped. The foam suspension 29 is 5 mm deep by 5 mm wide and extends 100 mm from each short end of the frame. The frame 57 is formed with a structural bar 56 to which an additional panel suspension mounting block 55 is adhered. The mounting block 55 is of resilient foam and may be considered a tuning block since its purpose is to stabilise or restrain a selected resonance in the panel. The block 55 has a length of 30 mm and is located approximately 250 mm from a short edge 29 of the frame 57.

FIG. 8 shows the frequency response for the panel loudspeaker of FIG. 6 when mounted in the frame of FIG. 7, in other words in an open back arrangement. The upper and lower responses 15, 17 represent the responses for the panel with and without a side baffle, respectively. There are good results in a broad frequency range from 100 Hz to 20 kHz and a beneficial acoustic response is provided over the whole of this very broad frequency range.

FIG. 9a and FIG. 9b together show a small panel loudspeaker module for use in a television. The module comprises a panel 61 to which is attached a transducer 63. The panel 61 is suspended on a frame 67 via four intermediary suspension mounts 71 of resilient foam. The suspension mounts 71 are designed to partially restrain the short ends of the panel so that the short ends of the panel move significantly less than the centre of the panel. By locating the four mounts towards the short ends of the panel, a simple approximation to the U-shaped suspension of FIGS. 4 and 7 is obtained. The frame 67 is open and surrounds the suspension mounts 71. The panel module has dimensions of 213 mm by 75 mm. The panel 61 is 200 mm by 40 mm and hence has an aspect ratio of 5:1. The panel is 2 mm thick and is a Rohacell core sandwiched between two glass veil reinforced plastics skins. The frame 67 is of aluminium.

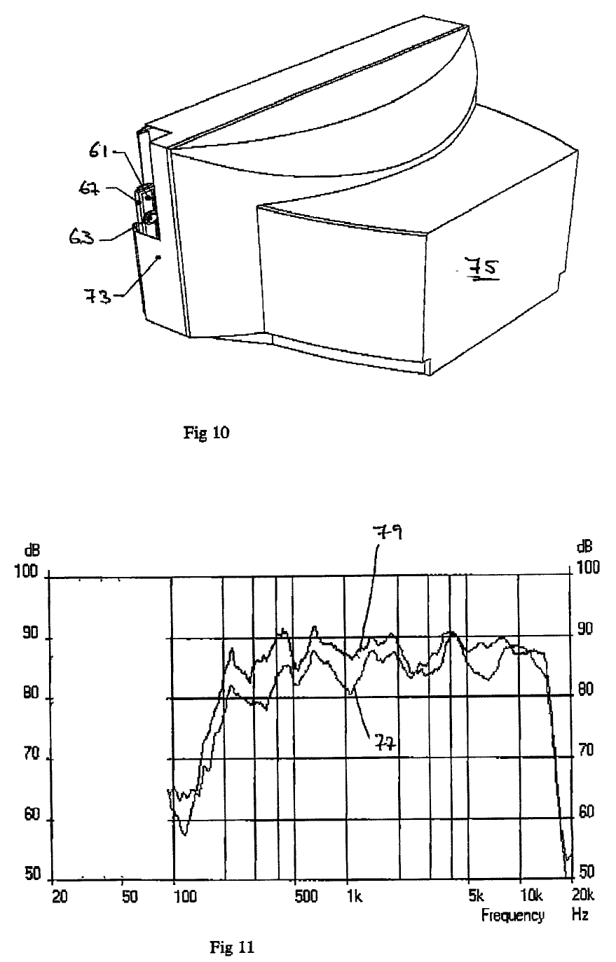

FIG. 10 shows the module of FIGS. 9a and 9b mounted in the front moulding 73 of a television 75. Two modules are mounted in the front moulding, one at either side of the television screen (not shown) to provide stereo channels. The panel is mounted so the plane of the panel is parallel to the plane of the screen.

FIG. 11 shows two frequency responses measured 1 m from the centre of the screen of the television of FIG. 10. The lower response 77 represents the measurements when only a left panel module similar to that of FIGS. 9a and 9b is connected to an audio input. The upper response 79 shows the measurements when both left and right panel modules are connected. The measurements are taken at 1 m from the television screen. As is to be expected, the output is greater when both modules are in use.

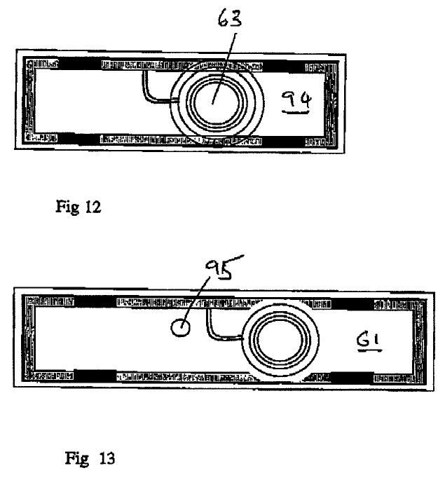

A small centre channel may also be added by mounting a small panel module of the kind shown in FIGS. 9a and 9b in the moulding of the television above the television screen as shown in FIG. 12. The plane of the panel is parallel to that of the screen. The arrangement of the centre module corresponds to that of the larger stereo channels except that the panel 93 is only 120 mm by 40 mm by 2 mm and thus the module has an overall dimension of 133 mm by 53 mm.

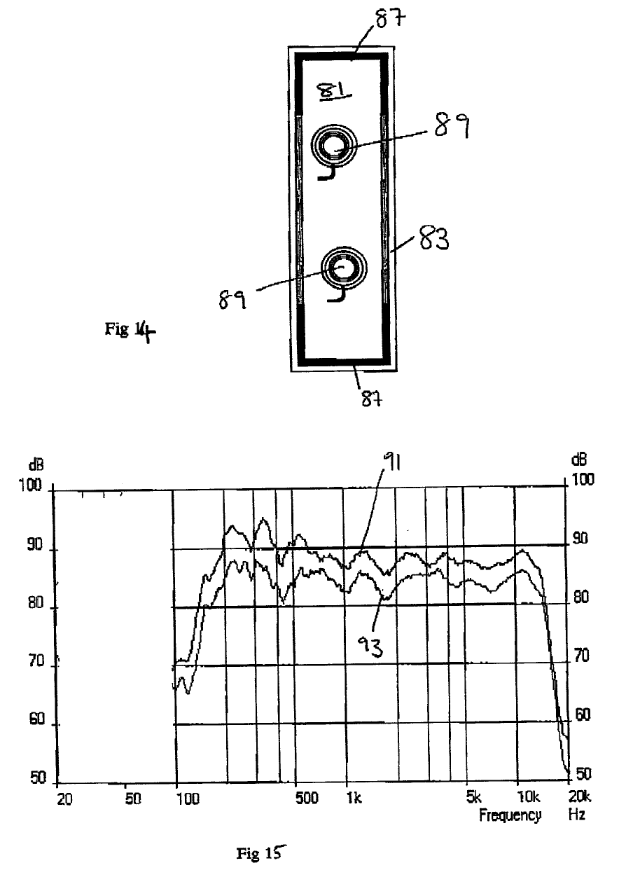

An alternative left or right channel module is shown in FIG. 13. The module corresponds to that of FIGS. 9a and 9b except that a mass 95 of 0.5 g has been mounted to the panel at a location 15 mm from a long edge and 75 mm from a short edge. The mass 95 is added to improve the modal distribution of the panel loudspeaker in the frequency range of interest.

As an alternative to the small panel module of FIGS. 9a and 9b, a large panel module having dimensions of 350 mm by 95 mm and hence an aspect ratio of 3.7:1 may be used in the front moulding of a television. The large panel module is shown in FIG. 14 and is generally similar to that of FIGS. 9a and 9b. The large panel module comprises a panel 81, supported on a frame 83 by U-shaped resilient foam supports 87. Two transducers 89 are mounted on the panel 81 to provide additional power output.

FIG. 15 shows two frequency responses, the lower response 93 represents the measurements when only a left panel module similar to that of FIG. 14 is connected to an audio input. The upper response 91 shows the measurements when both left and right panel modules are connected. The measurements are taken at 1 m from the television screen.

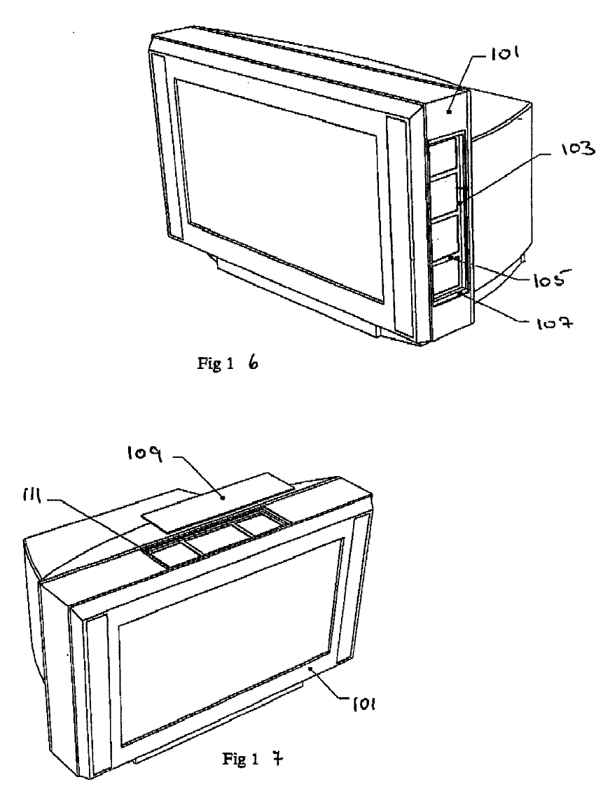

As an alternative to the mounting arrangement of FIG. 10, large panel loudspeakers may be mounted in the television moulding 101 with the plane of the panel perpendicular to the plane of the television screen as shown in FIGS. 16 and 17. In both mounting arrangements the moulding 101 is provided with a recess 103 in which a panel loudspeaker module, such as one shown in FIGS. 9a and 9b, is mounted. The recess 103 is provided with strengthening ribs 105 to maintain the structural integrity of the recess and an additional cavity 107 for a grille which covers the loudspeaker. In FIG. 16, the speaker is to be mounted in the side of the front moulding 101 to provide a right channel for stereo reproduction. In FIG. 17, the speaker 109 is to be mounted in a recess 111 in the top of the front moulding to provide a centre channel.

As detailed above the panels of each embodiment have aspect ratios in the range of 3:1 (FIG. 12) to 5:1 (FIG. 13) and thus may be considered to be elongate or high aspect ratio panels. Although, as noted above, the general teaching of WO97/09842, U.S. application Ser. No. 08/707,012 and other applications of New Transducers Limited is applied to determine transducer and/or mass/damping locations and panel materials, the high aspect ratios are not considered or taught in such applications. Accordingly, the general teaching of such applications which is to ensure good modal distribution is adapted to apply to such high aspect ratios and in particular, the termination conditions of each panel appear critical to acoustic performance.

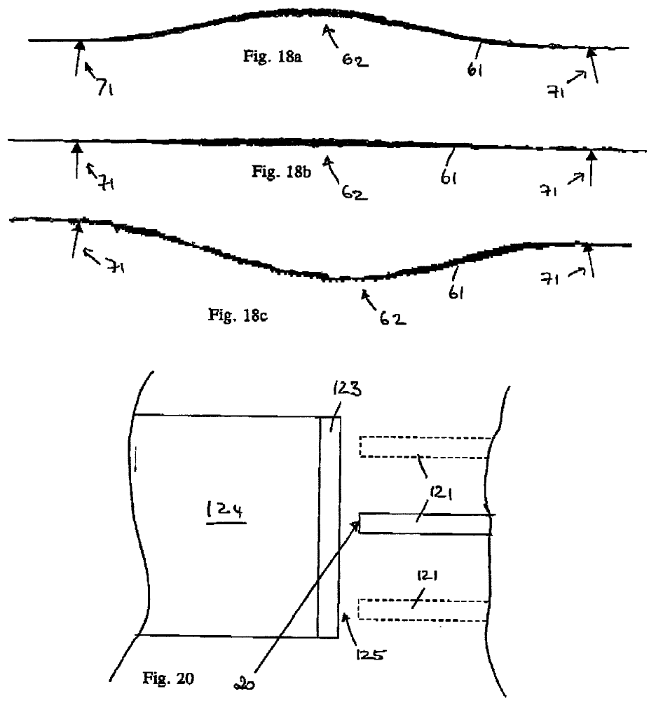

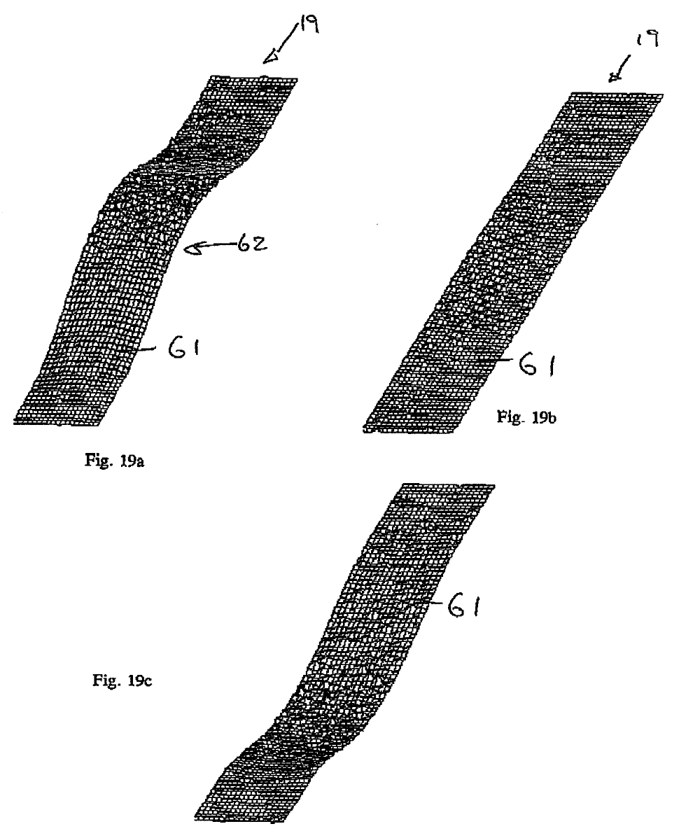

FIGS. 18a, 18b and 18c, and FIGS. 19a, 19b and 19c show the movement of the panel 61 of the embodiment of FIGS. 9a and 9b at three snapshots in time. FIGS. 18b and 19b show the rest position of the panel 61. FIGS. 18a and 19a show the maximum upper displacement of the panel 61, and FIGS. 18c and 19c show the maximum lower displacement of the panel 61. The central region 62 of the panel has a displacement which is far greater than the short edges 19 of the panel 61. The short edges 19 of the panel are relatively stationary whereas there is substantial movement of the central region. FIGS. 18a, 18b and 18c also show the position and direction of the pivot point for each of the four suspension mounts 71.

FIG. 20 shows the movement of the central region of a panel 121 relative to a portion of a panel support 123, which may be a frame or an enclosure adjacent a baffle 124. The rest or median position of the panel 121 is indicated in solid lines and the positions of upper and lower displacement are indicated in dashed lines. The long edge 20 of the panel is adjacent the support and defines a small air gap 125 between the panel and the support 123. The panel is free to move relative to the panel support in the air gap, but the panel edge is effectively baffled by the support and baffle combination.

Various modifications and alternative embodiments of the invention will be apparent to those skilled in the art without departing from the scope of the invention, which is limited only be the following claims.

1. A panel loudspeaker comprising an elongate panel which supports resonant bending wave modes, a transducer mounted on the panel to excite resonant bending wave modes to produce an acoustic output, a panel support and a panel suspension for suspending the panel on the support, the panel suspension being located in the region of each short end of the panel to partially restrain the short ends so that the motion of a central region of the panel is significantly greater than the motion of the short ends.

2. A panel loudspeaker according to claim 1, wherein the panel is provided with a longitudinal reinforcement member along its length.

3. A panel loudspeaker according to claim 2, wherein the reinforcement member comprises a stiffening strip on each side of the panel.

4. A panel loudspeaker according to claim 2 or claim 3, wherein the reinforcement member extends across only part of the width of the panel.

5. A panel loudspeaker according to claim 2 or claim 3, wherein the reinforcement member is provided on a central region of the area of the panel in the form of a strip across about 3% to about 40% of the width of the panel.

6. A panel loudspeaker according to claim 5, wherein the transducer is mounted so as to bridge an edge of the reinforcement member.

7. A panel loudspeaker according to claim 4, wherein the transducer is mounted so as to bridge an edge of the reinforcement member.

8. A panel loudspeaker according to claim 1, wherein the suspension comprises U-shaped resilient mountings attached to each opposed short end of the panel.

9. A panel loudspeaker according to claim 8, wherein each mounting extends approximately 30% along the length of the panel from each short end.

10. A panel loudspeaker according to claim 8 or claim 9, wherein the suspension further comprises a tuning block which is mounted to the panel to suppress a selected unwanted resonance in the panel.

11. A panel loudspeaker according to claim 10, wherein the tuning block is mounted on the panel between the suspensions at each short end of the panel.

12. A panel loudspeaker according to claim 1, wherein the suspension comprises four resilient mounting blocks with each mounting block attached to the panel in the region of a respective corner of the panel.

13. A panel loudspeaker according to claim 1, claim 8 or claim 12, wherein an air gap is defined between each long edge and panel support in regions of the panel which are not attached to the suspension so that the long edge moves in the air gap when the panel loudspeaker is producing an acoustic output.

14. A panel loudspeaker according to claim 1, wherein the support is an open frame.

15. A panel loudspeaker according to claim 1, wherein the support is an enclosure which encloses a rear face of the panel.

16. A panel loudspeaker according to claim 15, wherein the enclosure comprises a vent.

17. A panel loudspeaker according to claim 1, wherein a mass is added to the panel at a selected position to enhance the acoustic output of the loudspeaker.

18. A panel loudspeaker according to claim 1, wherein the transducer is an inertial transducer.

19. A panel loudspeaker according to claim 1, wherein two transducers are mounted to the panel to drive the panel.

20. A panel loudspeaker according to claim 1 or claim 19, wherein a damping pad is mounted to the panel at a location of the or each transducer.

21. A panel loudspeaker according to claim 20, wherein the or each transducer is mounted to the panel via a mounting coil and the damping pad is located within the coil.

22. A panel loudspeaker comprising an elongate panel which supports resonant bending wave modes, a transducer mounted on the panel to excite resonant bending wave modes to produce an acoustic output, a panel support and a panel suspension for suspending the panel on the support, the panel having an aspect ratio in the range of about 1.7:1 to about 10:1, and the panel suspension being located in the region of each short end of the panel to partially restrain the short ends so that the motion of a central region of the panel is significantly greater than the motion of the short ends.

23. A panel loudspeaker according to claim 22, wherein the panel has an aspect ratio in the range of about 3:1 to about 5:1.

24. A panel loudspeaker according to claim 22 or claim 23, wherein the panel is provided with a longitudinal reinforcement member along its length.

25. A panel loudspeaker according to claim 24, wherein the reinforcement member comprises a stiffening strip on each side of the panel.

26. A panel loudspeaker according to claim 22, wherein the panel is provided with a longitudinal reinforcement member along its length and extending across only part of the width of the panel.

27. A panel loudspeaker according to claim 26, wherein the reinforcement member is provided on a central region of the area of the panel in the form of a strip across about 3% to about 40% of the width of the panel.

28. A panel loudspeaker according to claim 27, wherein the transducer is mounted so as to bridge an edge of the reinforcement member.

29. A panel loudspeaker according to claim 28, wherein the reinforcement member comprises a stiffening strip on each side of the panel.

30. A panel loudspeaker according to claim 29, wherein the panel has an aspect ratio in the range of about 3:1 to about 5:1.

31. A television comprising a screen, a moulding surrounding the screen, and at least one panel loudspeaker mounted in the moulding adjacent the screen, the panel loudspeaker comprising:
an elongate panel which supports resonant bending wave modes,
a transducer mounted on the panel to excite resonant bending wave modes to produce an acoustic output,
a panel support mounted in the moulding, and
a panel suspension for suspending the panel on the support, the panel suspension being located in the region of each short end of the panel to partially restrain the short ends so that the motion of a central region of the panel is significantly greater than the motion of the short ends.

32. A television according to claim 31, wherein the panel is provided with a longitudinal reinforcement member along its length.

33. A television according to claim 32, wherein the reinforcement member comprises a stiffening strip on each side of the panel.

34. A television according to claim 32 or claim 33, wherein the reinforcement member extends across only part of the width of the panel.

35. A television according to claim 32 or claim 33, wherein the reinforcement member is provided on a central region of the area of the panel in the form of a strip across about 3% to about 40% of the width of the panel.

36. A television according to claim 35, wherein the transducer is mounted so as to bridge an edge of the reinforcement member.

37. A television according to claim 34, wherein the transducer is mounted so as to bridge an edge of the reinforcement member.

38. A television according to claim 31, wherein the suspension comprises U-shaped resilient mountings attached to each opposed short end of the panel.

39. A television according to claim 38, wherein each mounting extends approximately 30% along the length of the panel from each short end.

40. A television according to claim 38 or claim 39, wherein the suspension further comprises a tuning block which is mounted to the panel to suppress a selected unwanted resonance in the panel.

41. A television according to claim 40, wherein the tuning block is mounted on the panel between the suspensions at each short end of the panel.

42. A television according to claim 31, wherein the suspension comprises four resilient mounting blocks with each mounting block attached to the panel in the region of a respective corner of the panel.

43. A television according to claim 31, claim 38 or claim 42, wherein an air gap is defined between each long edge and panel support in regions of the panel which are not attached to the suspension so that the long edge moves in the air gap when the panel loudspeaker is producing an acoustic output.

44. A television according to claim 31, wherein the support is an open frame.

45. A television according to claim 31, wherein the support is an enclosure which encloses a rear face of the panel.

46. A television according to claim 45, wherein the enclosure comprises a vent.

47. A television according to claim 31, wherein a mass is added to the panel at a selected position to enhance the acoustic output of the loudspeaker.

48. A television according to claim 31, wherein the transducer is an inertial transducer.

49. A television according to claim 31, wherein two transducers are mounted to the panel to drive the panel.

50. A television according to claim 31 or claim 49, wherein a damping pad is mounted to the panel at a location of the or each transducer.

51. A television according to claim 50, wherein the or each transducer is mounted to the panel via a mounting coil and the damping pad is located within the coil.

52. A television according to claim 31, wherein the panel loudspeaker is mounted so that the plane of the panel is parallel to the plane of the screen.

53. A television according to claim 52, wherein three panel loudspeakers are mounted in the moulding to provide left, right and centre channels for audio reproduction.

54. A television comprising a screen, a moulding surrounding the screen, and at least one panel loudspeaker mounted in the moulding adjacent the screen, the panel loudspeaker comprising:
an elongate panel which supports resonant bending wave modes, the panel having an aspect ratio in the range of about 1.7:1 to about 10:1,
a transducer mounted on the panel to excite resonant bending wave modes to produce an acoustic output,
a panel support mounted in the moulding, and
a panel suspension for suspending the panel on the support, the panel suspension being located in the region of each short end of the panel to partially restrain the short ends so that the motion of a central region of the panel is significantly greater than the motion of the short ends.

55. A panel loudspeaker according to claim 54, wherein the panel has an aspect ratio in the range of about 3:1 to about 5:1.

56. A panel loudspeaker according to claim 54 or claim 55, wherein the panel is provided with a longitudinal reinforcement member along its length.

57. A panel loudspeaker according to claim 56, wherein the reinforcement member comprises a stiffening strip on each side of the panel.

58. A panel loudspeaker according to claim 54, wherein the panel is provided with a longitudinal reinforcement member along its length and extending across only part of the width of the panel.

59. A panel loudspeaker according to claim 58, wherein the reinforcement member is provided on a central region of the area of the panel in the form of a strip across about 3% to about 40% of the width of the panel.

60. A panel loudspeaker according to claim 59, wherein the transducer is mounted so as to bridge an edge of the reinforcement member.

61. A panel loudspeaker according to claim 60, wherein the reinforcement member comprises a stiffening strip on each side of the panel.

62. A panel loudspeaker according to claim 61, wherein the panel has an aspect ratio in the range of about 3:1 to about 5:1.
